(19) United States
(12) Patent Application Publication
(10) Pub. No.: US 2018/0094740 A1
(43) Pub. Date: Apr. 5, 2018

(54) MOUNTING STRUCTURE OF SOLENOID VALVE FOR OPERATION, AND FLUID CONTROL VALVE

(71) Applicant: CKD CORPORATION, Komaki-shi, Aic (JP)

(72) Inventor: Tatsuhito AOYAMA, Kasugai-shi (JP)

(73) Assignee: CKD CORPORATION, Komaki-shi, Aichi (JP)

(21) Appl. No.: 15/566,985

(22) PCT Filed: Jan. 27, 2017
(86) PCT No.: PCT/JP2017/002886

§ 371 Date: Oct. 16, 2017

(30) Foreign Application Priority Data
Mar. 30, 2016 (JP) 2016-068500

(51) Int. Cl. F16K 31/02; F16K 27/00

(52) U.S. Cl. CPC F16K 31/02; F16K 27/00

(57) ABSTRACT

A mounting structure of a solenoid valve for operation on a cylinder provided with an operation port, the solenoid valve being configured to control operation fluid to be supplied to the cylinder, includes a mounting block attached with the solenoid valve, and a mounting screw threadedly engaged with internal threads of the operation port to mount the mounting block on the cylinder. The mounting block includes an inlet passage for supplying the operation fluid to the solenoid valve, an outlet passage for flowing the operation fluid controlled by the solenoid valve, and a through hole through which the mounting screw is inserted and with which the outlet passage is communicated. The mounting screw includes an inner passage to communicate the operation port with the outlet passage. Seal members seal between an inner wall of the through hole and the mounting screw.

### TECHNICAL FIELD

The present invention relates to a mounting structure of a solenoid or electromagnetic valve for operation, and a fluid control valve, including a cylinder provided with an operation port and a solenoid valve for operation for controlling operation fluid to be supplied to the cylinder.

### BACKGROUND ART

A semiconductor manufacturing device, for example, is configured to supply gas (one example of control fluid) to a wafer placed in a chamber to form a film on the wafer. The quality of this film depends on the amount of gas supplied. Therefore, the chamber is provided, at a gas supply port, with a fluid control valve for controlling gas.

For example, a fluid control valve in a first conventional art (see Patent Document 1, for example) is driven by a solenoid valve for operation. This solenoid valve for operation is connected, through a tube, to a cylinder of a drive section provided in the fluid control valve. The tube is connected to the cylinder through a joint threadedly engaging with the cylinder. When the solenoid valve for operation is de-energized, no operation fluid is supplied to the cylinder through the tube and thus the fluid control valve is in a valve-closed state. In contrast, when the solenoid valve for operation is energized, the operation fluid is supplied to the cylinder through the tube, driving the drive section to bring the valve section into a valve-open state.

Meanwhile, miniaturization and density growth of semiconductors have been advanced. In a semiconductor manufacturing process, accordingly, an ALD (atom layer deposition) process has been used, which can accurately form even a thin film of a several-nanometer thickness and also form a film even on a portion having a high aspect ratio. This ALD process controls the film thickness at nanometer scale by repeating supply and exhaust of gas many times. In this case, the fluid control valve performs valve opening and closing operations at high frequency. Further, the amount of gas supplied per valve opening operation is small. In the fluid control valve in the first conventional art in which the solenoid valve for operation and the cylinder are connected through the tube, a flow passage extending from the solenoid valve for operation to the operation port tends to be long, resulting in slow response at the time of valve opening and closing.

FIG. 12 is a cross sectional view of a fluid control valve 201 in a second conventional art (see Patent Document 2, for example). In the fluid control valve 201, a solenoid valve for operation 211 is mounted on an upper end part 206C of a cylinder 206 of a drive section 203 through a mounting block 210. The mounting block 210 is attached to the cylinder 206 in such a way that an outlet passage 210B is directly connected to an operation port 206A of the cylinder 206.

In the fluid control valve 201, when the solenoid valve for operation 211 is de-energized, the operation fluid is not output to the outlet passage 210B of the mounting block 210. In this case, piston plates 213A and 213B are pushed down by a return spring 232 through a piston rod 209 and a stem 231 to bring a diaphragm 221 of a valve section 202 into contact with a valve seat 222. In the fluid control valve 201, reversely, when the solenoid valve for operation 211 is energized, a supply amount of the operation fluid having flowed in an inlet passage 210A of the mounting block 210 is controlled by the solenoid valve for operation 211 and then is output to the outlet passage 210B of the mounting block 210. The operation fluid is supplied to a cylinder chamber 207 via an operation port 206A formed in the cylinder 206, a holding hole 206B, a central passage 209A formed in the piston rod 209, and communication passages 209B and 209C, and then the operation fluid applies pressure to the piston plates 213A and 213B placed above and below a fixed plate 212, in a direction array from the valve seat 222. Accordingly, the piston plates 213A and 213B move the stem 231 upward against the return spring 232. The diaphragm 221 is deformed by its own reactive force up to a position where it contacts the stem 231, separating from the valve seat 222.

In the fluid control valve 201 configured as above, the solenoid valve for operation 211 is mounted near the operation port 206A and thus the flow passage from the solenoid valve for operation 211 to the operation port 206A is shorter than the flow passage in the fluid control valve having the solenoid valve for operation and the cylinder connected with each other through the tube. Therefore the fluid control valve 201 can perform valve opening and closing operations with good response.

### RELATED ART DOCUMENTS

### Patent Documents

Patent Document 1: Japanese Unexamined Patent Application Publication No. 2014-109314
Patent Document 2: Japanese Patent No. 5054904

### SUMMARY OF INVENTION

### Problems to be Solved by the Invention

However, the fluid control valve 201 in the second conventional art has the following problems. In the fluid control valve 201, specifically, the mounting block 210 is attached to the cylinder 206 in such a way that the outlet passage 210B is directly connected to the operation port 206A. Therefore, for instance, if a fluid control valve with a tube connected to the operation port through a joint is already provided to a chamber, the solenoid valve for operation could not be directly attached to the cylinder of the fluid control valve. Thus, the existing fluid control valve had to be replaced in whole. The fluid control valve 201 further needs a special shape of the cylinder 206 to attach the mounting block 210, resulting in high manufacturing cost of the cylinder 206.

The present invention has been made in view of the circumstances to solve the above problems and has a purpose to provide an inexpensive mounting structure of a solenoid valve for operation to allow retrofitting of the solenoid valve for operation near an operation port, and a fluid control valve.

### Means of Solving the Problems

One aspect of the invention provides the following configuration.
(1) A mounting structure of a solenoid valve for operation to mount the solenoid valve for operation on a cylinder provided with an operation port, the solenoid valve for operation being configured to control operation fluid to be supplied to the cylinder, is characterized that the operation pun has internal threads, the mounting structure includes a mounting block to which the solenoid valve for operation is attached, and a mounting screw threadedly engaged with the internal threads to mount the mounting block to the cylinder, the mounting block includes: an inlet passage in which the operation fluid flows and through which the operation fluid is supplied to the solenoid valve for operation; an outlet passage in which the operation fluid having been controlled by the solenoid valve for operation flows from the solenoid valve; and a through hole through which the mounting screw is inserted, the through hole being communicated with the outlet passage, the mounting screw includes an inner passage for providing communication between the operation port and the outlet passage, and the mounting structure further includes a seal member for sealing between an inner wall of the through hole and the mounting screw.

In the aforementioned mounting structure, the mounting block includes the through hole through which the mounting screw is inserted and placed in threaded engagement with the internal threads of the operation port. Therefore, for example, when a tube for supplying the operation fluid has been connected to the operation port through a joint, the joint is detached and instead the mounting screw is inserted through the through hole of the mounting block, and the moving screw is further threadedly engaged in the operation port to mount the mounting block attached with the solenoid valve for operation on the cylinder. Accordingly, the solenoid valve for operation can be retrofitted near the operation port.

The mounting block includes the inlet passage in which the operation fluid flows and through which the operation fluid is supplied to the solenoid valve for operation, the outlet passage in which the operation fluid having been controlled by the solenoid valve for operation flows from the solenoid valve, and the through hole through which the mounting screw is inserted, the through hole being communicated with the outlet passage. The mounting screw includes the inner passage for providing communication between the operation port and the outlet passage. Accordingly, when the operation fluid is supplied to the solenoid valve for operation through the inlet passage of the mounting block, a flow rate of the operation fluid is controlled in the solenoid valve and then this operation fluid is output to the operation port through the outlet passage of the mounting block, the through hole, and the inner passage of the mounting screw.

Since the seal member seals between the inner wall of the through hole and the mounting screw, the operation fluid is supplied precisely with a flow rate adjusted by the solenoid valve for operation to the cylinder.

With the aforementioned configuration, consequently, the mounting block attached with the solenoid valve for operation is mounted on the cylinder by use of the internal threads of the operation port which is threadedly engageable with a joint for connecting a tube. Thus, the solenoid valve for operation can be retrofitted to an existing cylinder. Further, the cylinder can also be used both in a case of using the tube and in a case of using the mounting block. Consequently, the cylinder can be manufactured at low cost.

(2) In the mounting structure described in (1), preferably, the mounting screw includes a shaft portion inserted through the through hole, the shaft portion having an outer peripheral surface formed circumferentially with a recessed portion having a wall surface in which the inner passage opens.

With the above structure, the recessed portion is circumferentially formed on the outer peripheral surface of the shaft portion of the mounting screw and the inner passage opens in the wall surface of the recessed portion. Even when the mounting block is mounted in any orientation on the cylinder, the outlet passage is allowed to communicate with the inner passage through a clearance created between the recessed portion and the inner circumferential surface of the through hole, thereby allowing supply of the operation fluid to the operation port. Consequently, according to the above structure, the mounting block can be mounted in any orientation on the cylinder.

(3) A fluid control valve is characterized by including the mounting structure of a solenoid valve for operation described in (1) or (2).

The aforementioned structure can achieve, in addition to the above operations and effects in (1) or (2), a shorter flow passage between the solenoid valve for operation and the operation port than in a structure using a tube to connect the solenoid valve for operation to the operation port and thus can control the amount of operation fluid to be supplied at a position near the operation port. Accordingly, even when the control fluid is to be supplied in small amounts at high frequency, the fluid control valve configured as above can perform opening and closing operations with good response. This function can be added to an existing fluid control valve with ease and low cost simply by replacing the tube having been connected to the operation port by the mounting block attached with the solenoid valve for operation and then connecting the detached tube to the mounting block. In the aforementioned structure, furthermore, when the solenoid valve for operation is to be retrofitted to an existing fluid control valve, the mounting block and the solenoid valve for operation can be freely adjusted to face in any direction in relation to devices arranged around the fluid control valve. Thus, the solenoid valve for operation can be easily retrofitted.

### Effects of the Invention

The present invention can provide a mounting structure of a solenoid valve for operation, capable of retrofitting this solenoid valve near an operation port at low cost and a fluid control valve.

### BRIEF DESCRIPTION OF THE DRAWINGS

FIG. 1 is a front view of a fluid control valve in embodiments of the present invention;

FIG. 2 is a top view of the fluid control valve shown in FIG. 1;

FIG. 3 is a side view of the fluid control valve shown in FIG. 1;

FIG. 4 is a top view of a mounting block;

FIG. 5 is a right side view of the mounting block shown in FIG. 4;

FIG. 6 is a cross sectional view taken along line A-A in FIG. 4;

FIG. 7 is a cross sectional view taken along line B-B in FIG. 4;

FIG. 8 is a cross sectional view taken along line C-C in FIG. 4;

FIG. 9 is a cross sectional view taken along line D-D in FIG. 6;

FIG. 10 is a view showing a structure of mounting a solenoid valve for operation, indicating flow directions of operation fluid;

FIG. 11 is a top view of a fluid control valve provided with a proximity sensor; and

FIG. 12 is a cross sectional view of a conventional fluid control valve.

### MODE FOR CARRYING OUT THE INVENTION

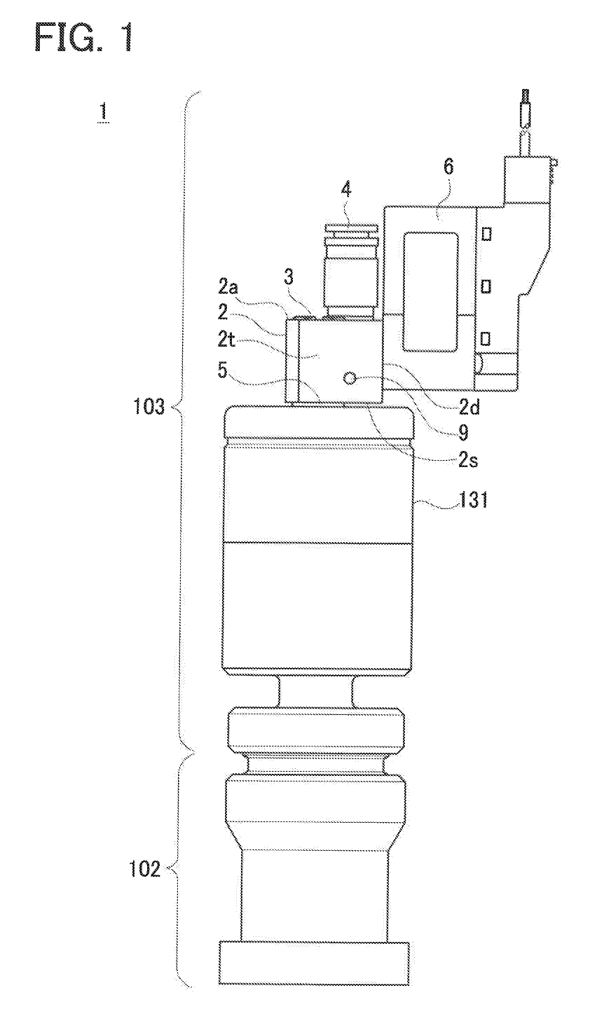

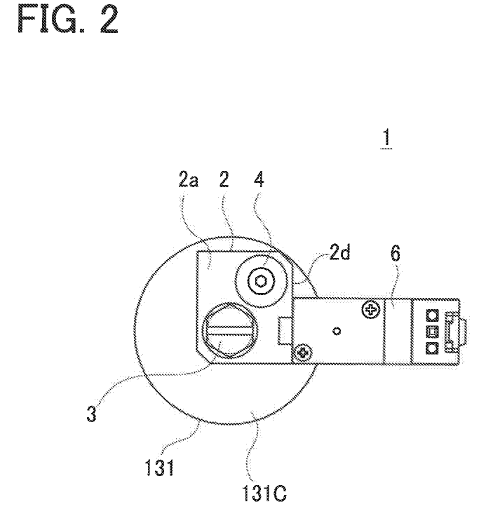

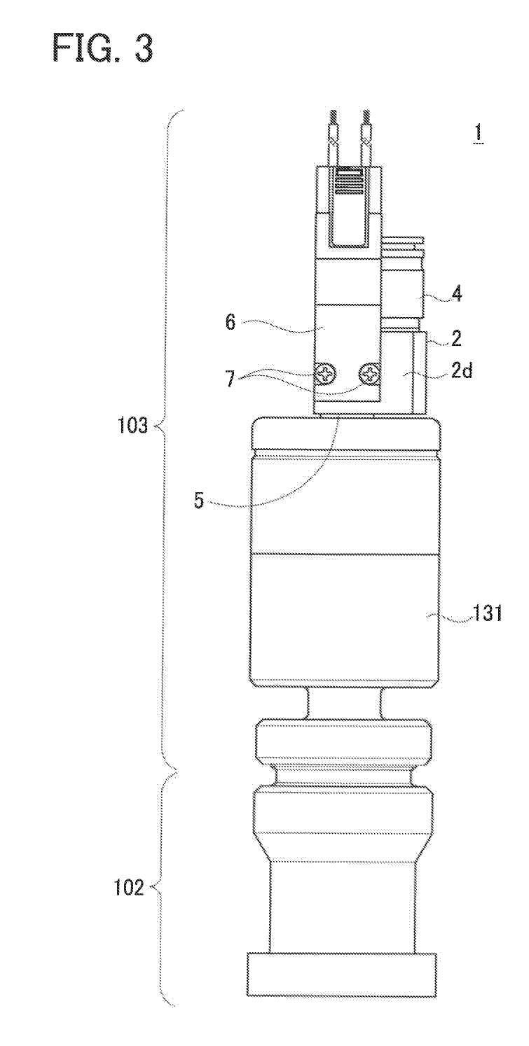

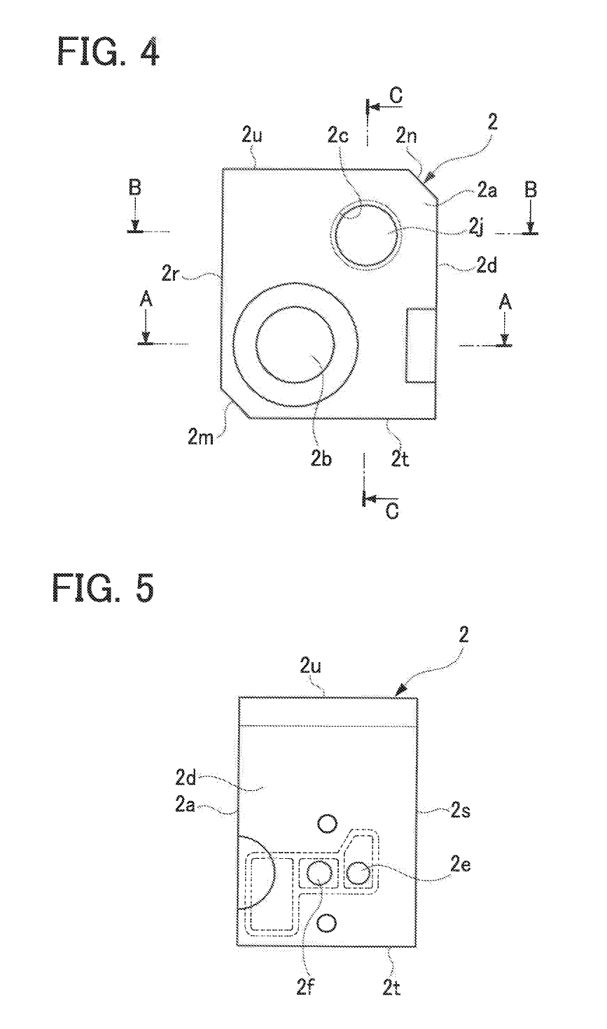

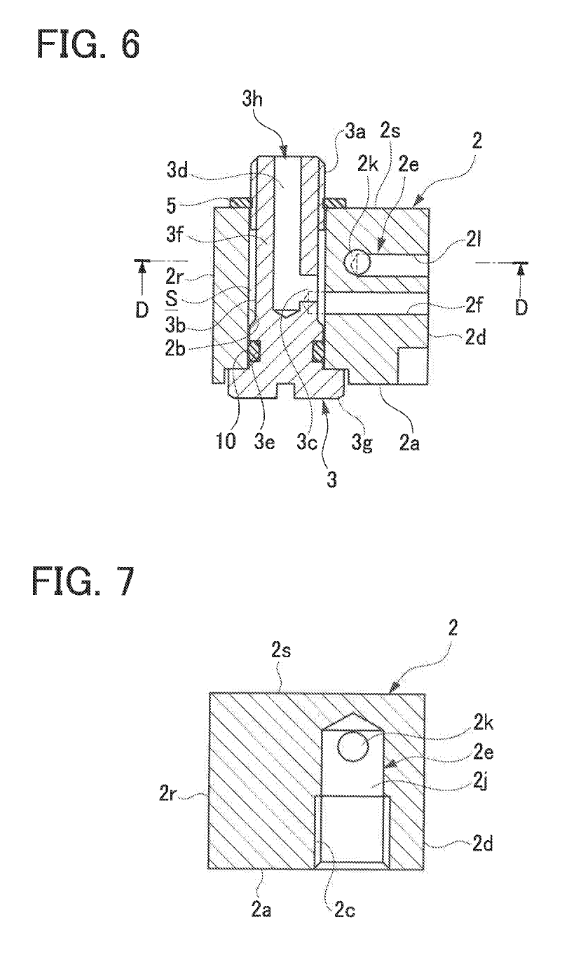

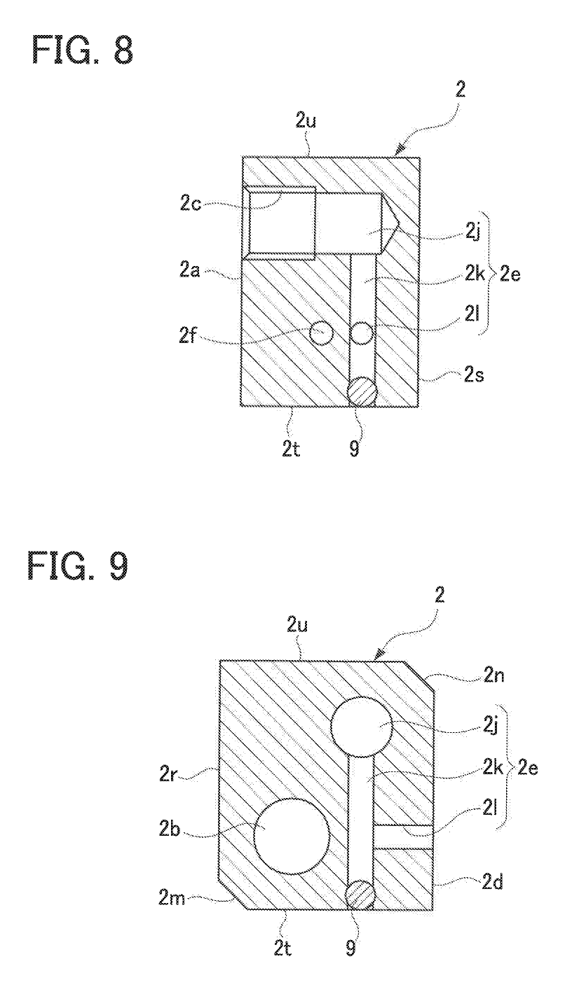

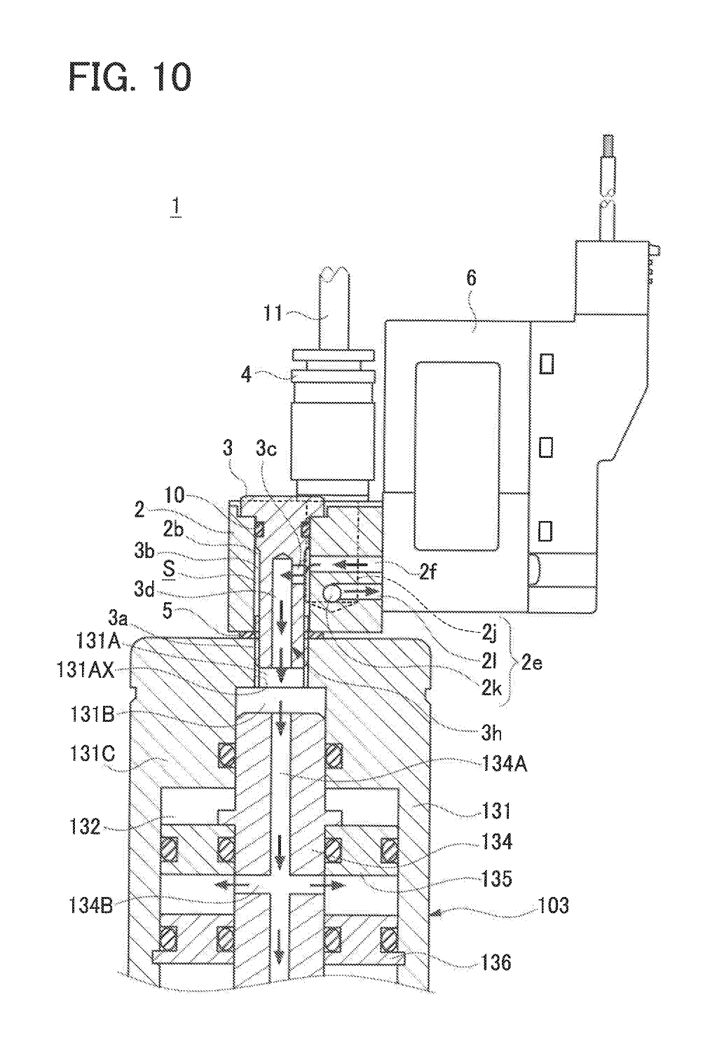

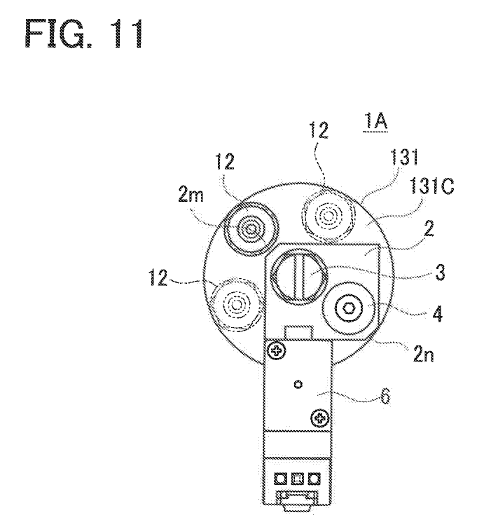

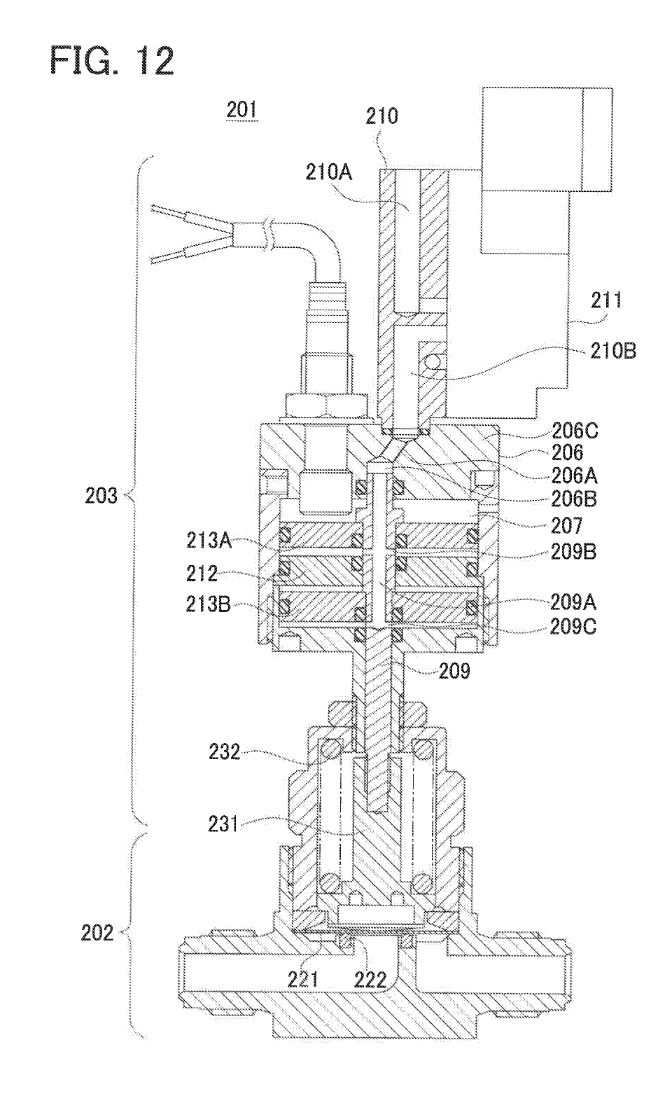

A detailed, description of a preferred embodiment of a mounting structure of a solenoid or electromagnetic valve for operation and a fluid control valve, which embody the present invention will now be given referring to the accompanying drawings. FIG. 1 is a front view of a fluid control valve 1 in the embodiment of the present invention. FIG. 2 is a top view of the fluid control valve 1 shown in FIG. 1. FIG. 3 is a side view of the fluid control valve 1 shown in FIG. 1. FIG. 4 is a top view of a mounting block 2. FIG. 5 is a right side view of the mounting block 2 shown in FIG. 4. FIG. 6 is a cross sectional view taken along line A-A in FIG. 4, FIG. 7 is a cross sectional view taken along line B-B in FIG. 4. FIG. 8 is a cross sectional view taken along line C-C in FIG. 4. FIG. 9 is a cross sectional view taken along line D-D in FIG. 6. FIG. 10 is a view showing the mounting structure of a solenoid valve for operation, indicating flowing directions of operation fluid. FIG. 11 is a top view of a fluid control valve 1A provided with a proximity sensor 12. It is to be noted that FIG. 6 describes a mounting screw 3 together with the mounting block 2 to explain clearly the relationship between an outlet passage 2f, a recessed portion 3b, and an inner passage 3h, whereas FIG. 9 omits the mounting screw 3.

The fluid control valve 1 in the present embodiment, as shown in FIG. 1, will be placed at a gas supply port of a chamber used in for example a semiconductor manufacturing process to control gas (one example of control fluid) to be supplied to the chamber. The fluid control valve 1 is provided with a valve section 102 for controlling gas and a drive section 103 for generating drive force upon supply of operation fluid (e.g., compression air) and imparting the generated drive force to the valve section 102. The structure of this valve section 102 is not particularly different from conventional ones. The drive section 103 is not particularly different from conventional ones excepting that a solenoid valve 6 for operation, or an operation solenoid valve 6, is mounted on a cylinder 131. Therefore, the following description is made with a focus on the mounting structure of a solenoid valve for operation.

As shown in FIGS. 1 to 3, the operation solenoid valve 6 is mounted on the cylinder 131 of the fluid control valve 1 through the mounting block 2. Specifically, the operation solenoid valve 6 is fixed to a third side surface 2d of the mounting block 2 with two fixing screws 7 as shown in FIG. 3.

The mounting block 2 is mounted on the cylinder 131 in such a way that external threads 3a formed on the outer periphery of a leading end portion of the mounting screw 3 inserted through the mounting block 2 threadedly engage with internal threads 131AX of an operation port 131A formed in an end part (hereinafter, referred to as “an upper end part”) 131C of the cylinder 131 on an opposite side of the valve section 102 as shown in FIG. 10. As shown in FIGS. 1 and 2, the mounting block 2 is provided with a joint 4 for connection of a tube 11 (see FIG. 10) for supplying operation fluid.

Next, the mounting block 2 and the mounting screw 3 will be described in detail. As shown in FIGS. 4 and 5, the mounting block 2 has a nearly rectangular parallelepiped shape having a first side surface 2a, a second side surface 2s, a third side surface 2d, a fourth side surface 2t, a fifth side surface 2r, and a sixth side surface 2u, and including chamfered portions 2m and 2n which are formed by chamfering diagonal corners.

As shown in FIG. 6, the mounting block 2 is formed with a through hole 2b penetrating from the first side surface 2a to the second side surface 2s. In this through hole 2b, the mounting screw 3 passes through without threadedly engaging the through hole 2b. As shown in FIG. 4, furthermore, in the first side surface 2a of the mounting block 2, an attaching hole 2j having a dead-end shape is open for allowing attachment of the joint 4. The attaching hole 2j is formed on its inner circumferential surface, with internal threads 2c threadedly engageable with the joint 4. The through hole 2b and the attaching hole 2j are provided in diagonally opposite positions respectively near the chamfered portion 2m or 2n in order to achieve a compact size of the mounting block 2.

As shown in FIG. 5, in the third side surface 2d of the mounting block 2, an inlet passage 2e to be connected to a supply port of the operation solenoid valve 6 and an outlet passage 2f to be connected to an exhaust port of the operation solenoid valve 6 are open.

As shown in FIG. 9, the inlet passage 2e is constituted of the attaching hole 2j, a bypass passage 2k, and a communication passage 21. As shown in FIGS. 7 and 8, the attaching hole 2j opens in the first side surface 2a of the mounting block 2 and has the internal threads 2c formed in an inner circumferential surface of an opening portion in which the joint 4 is threadedly engageable (see FIG. 1). The bypass passage 2k is a sideways hole that extends from the fourth side surface 2t in a direction perpendicular to the attaching hole 2j and communicates with the attaching hole 2j as shown in FIGS. 8 and 9. The opening of the bypass passage 2k is sealingly closed by a steel ball 9 serving as a sealing member. This steel ball 9 is made of a harder material than the mounting block 2 and is fixedly press-fitted in the mounting block 2 so as not to drop off from the mounting block 2 due to the pressure of operation fluid. In the present embodiment, the mounting block 2 is made of aluminum and the steel ball 9 is made of stainless steel. The communication passage 21 extends from the third side surface 2d in a direction perpendicular to the bypass passage 2k and communicates with the bypass passage 2k as shown in FIG. 9. This communication passage 21 opens in the third side surface 2d and is connected to a supply port of the operation solenoid valve 6.

The outlet passage 2f extends from the third side surface 2d in a direction perpendicular to the through hole 2b and communicates with the through hole 2b as shown in FIG. 6. In the mounting block 2, the mounting screw 3 is rotatably inserted through the through hole 2b so that the orientation of the mounting block 2 is freely changeable around the mounting screw 3.

The mounting screw 3 is formed with the recessed portion 3b on the outer periphery of, a shaft portion 3f which passes through the through hole 2b. The recessed portion 3b is formed in a position corresponding to the outlet passage 2f when the mounting block 2 is mounted on the cylinder 131 by means of the mounting screw 3, in which a clearance S is created between the mounting screw 3 and the inner wall of the through hole 2b to allow the operation fluid to easily flow from the outlet passage 2f to the through hole 2b. The recessed portion 3b is annularly formed in a circumferential direction along the outer peripheral surface of the shaft portion 3f. Accordingly, even when the mounting block 2 is attached in any orientation to the mounting screw 3, the recessed portion 3b can achieve proper position adjustment with the outlet passage 2f.

The mounting screw 3 has a hole 3d formed in a bottom-closed cylindrical shape extending along an axial direction from a leading end face (an upper end face in FIG. 6). The mounting screw 3 further has a communication area 3c extending from the outer peripheral surface of the shaft portion 3f in a direction perpendicular to the axis of the mounting screw 3. The communication area 3c opens in the wall surface of the recessed portion 3b. Thus, the operation fluid supplied to the recessed portion 3b flows through the communication area 3c and the hole 3d and then flows to the operation port 131A (see FIG. 10). In the present embodiment, the mounting screw 3 includes the inner passage 3h, which is constituted of the hole 3d and the communication area 3c, to allow communication between the outlet passage 2f and the operation port 131A.

The mounting screw 3 is provided with a seal member 10 fitted in a seal groove 3e formed between the recessed portion 3b and a head portion 3g to seal between the shaft portion 3f and the inner circumferential surface of the through hole 2b. An annular seal member 5 is attached on a part of the mounting screw 3 protruding from the mounting block 2. When the mounting screw 3 is threadedly engaged in the operation port 131A to mount the mounting block 2 on the cylinder 131, the seal member 5 is pressed flat between the mounting block 2 and the cylinder 131 as shown in FIG. 10, thereby sealing between the shaft portion 3f and the inner circumferential surface of the through hole 2b. Thus, the recessed portion 3b of the mounting screw 3 is sealed at each side by the seal member 10 or the seal member 5 to prevent leakage of operation fluid out of the mounting block 2.

Herein, the entire structure of the fluid control valve 1 will be briefly described. As shown, in FIG. 10, a cylinder chamber 132 of the cylinder 131 is partitioned into an upper chamber and a lower chamber by a fixed plate 136. In the upper chamber, a piston plate 135 is slidably installed. In the lower chamber, even though not shown in FIG. 10, another piston plate 135 is also slidably installed. Those piston plates 135 are mounted on a piston rod 134.

The operation port 131A is formed in the center of the upper end face of the cylinder 131, penetrating therethrough to communicate with the cylinder chamber 132. The cylinder chamber 132 is formed, in its inner wall at an upper end surface, with a holding hole 131B coaxial with the operation port 131A. In this holding hole 131B, an upper end portion of the piston rod 134 is slidably inserted. The piston rod 134 is formed with a central passage 134A having a dead-end shape extending from an upper end face in an axial direction of the piston rod 134. A communication passage 134E is provided interesting with the piston rod 134 to bring the central passage 134A into communication with a space formed under the upper piston plate 135 on a valve seat side. It is to be noted that the piston rod 135 is farther formed with a communication passage, even though not shown FIG. 10, to bring the central passage 134A into communication with a space formed under the lower piston plate 135 on a valve seat side.

The valve section (FIG. 1.) is applied with a valve-closing force by a return spring not shown. When the operation fluid is supplied to the cylinder 131, the valve section 102 is valve-opened according to the balance between the internal pressure of the cylinder chamber 132 and the spring force of the return spring not shown.

Here, the following explanation shows for instance a procedure of retrofitting the operation solenoid valve 6 to an existing fluid control valve 1 having the operation port 131A to which a tube 11 has been connected through a joint as described in the first conventional art. As shown in FIG. 10, the fluid control valve 1 is formed, in the upper end part 131C of the cylinder 131, with the holding hole 131B for holding the piston rod 134 in a slidable fashion. The upper end part 131C is formed with the operation port 131A coaxial with the holding hole 131B. To the existing fluid control valve 1, the tube 11 has been connected through the joint threadedly engaged in the operation port 131A. When the operation solenoid valve 6 is to be retrofitted to this existing fluid control valve 1, the joint engaged in the operation port 131A of the existing fluid control valve 1 is disengaged from the operation port 131A.

As shown in FIG. 10, the shaft portion 3f of the mounting screw 3 is designed with the same diameter as the joint detached as above. This mounting screw 3 is inserted through the through hole 2b of the mounting block 2. The seal member 5 is attached on the leading end portion (a lower end portion in FIG. 10) of the mounting screw 3. Therefore, the mounting screw 3 does not drop off from the mounting block 2. The operation solenoid valve 6 is secured to the mounting block 2 with fixing screws 7 (two fixing screws 7 in the present embodiment). The mounting block 2 is mounted on the cylinder 131 in such a way that the leading end portion (the external thread part 3a) of the mounting screw 3 is threadedly engaged with the internal threads 131AX of the operation port 131A. At that time, the seal member 5 is pressed flat between the mounting block 2 and the cylinder 131, thereby sealing the lower end opening of the through hole 2b in the figure. The upper end opening of the through hole 2b in the figure is sealed by the seal member 10. Further, the tube 11 is connected to the attaching hole 2j of the mounting block 2 through the joint 4. It is to be noted that, for example, if the joint disengaged from the internal threads 131AX of the operation port 131A has a size matching with the attaching hole 2j, this joint may be used as the joint 4. Alternatively, for example, if the joint disengaged from the internal threads 131AX of the operation port 131A does not have a size matching with the attaching hole 2j, another joint may be used as the joint 4.

In the mounting block 2 mounted on the cylinder 131, the outlet passage 2f communicates with the clearance S created between the inner circumferential surface of the through hole 2b and the recessed portion 3b of the mounting screw 3. Since the recessed portion 3b is provided circumferentially, the mounting block 2 can bring the outlet passage 2f into communication with the recessed portion 3b even when the mounting block 2 is turned in any direction within 360 degrees with respect to the mounting screw 3. The clearance S communicates with the operation port 131A through the inner passage 3h (the communication area 3c and the hole 3d).

Next, operations of the fluid control valve 1 on which the operation solenoid valve 6 is mounted will be described below, in the fluid control valve 1, operation fluid is supplied to the mounting block 2 through the tube 11 and the joint 4. Specifically, the operation fluid is supplied to a supply port of the operation solenoid valve 6 through the inlet passage 2e (the attaching hole 2j, the bypass passage 2k, and the communication passage 21) of the mounting block 2.

During non-energization, the operation solenoid valve 6 shuts off communication between the supply port and the exhaust port and thus does not supply operation fluid to the outlet passage 2f. In this case, the fluid control valve 1 is in a valve-closed state of the valve section 102.

During energization, in contrast, the operation solenoid valve 6 allows communication between the supply port and the exhaust port and controls the amount of operation fluid to be supplied to the outlet passage 2f according to an amount of electric power applied to the operation solenoid valve 6. The operation fluid with a flow rate having been controlled by the operation solenoid valve 6 is allowed to flow to the operation port 131A through the outlet passage 2f clearance S (through hole 2b and recessed portion 3b), and inner passage 3h (communication area 3c and hole 3d). Thereafter, the operation fluid is allowed to further flow to the cylinder chamber 132 through the holding hole 131B of the cylinder 131, and the central passage 134A and the communication passage 134B of the piston rod 134 thereby applying pressure to the piston plate 135 in a direction opposite the valve section 102 (i.e., in a direction away from the valve section 102). Thus, the valve section 102 is brought in a valve-open state to control gas.

In the mounting structure of a solenoid valve for operation in the present embodiment, as described above, the mounting block 2 is formed with the through hole 2b which the mounting screw 3 threadedly engaging with the internal threads of the operation port 131A passes through. Accordingly, for instance, when the tube 11 for supplying operation fluid has been connected to the operation port 131A of the cylinder 131 through a joint as in the first conventional art, this joint is detached and instead the mounting screw 3 is inserted through the through hole 2b of the mounting block 2 attached with the operation solenoid valve 6, and further the mounting screw 3 is threadedly engaged in the operation port 131A to mount the mounting block 2 on the cylinder 131. Accordingly, the operation solenoid valve 6 can be retrofitted near the operation port 131A.

The mounting block 2 includes the inlet passage 2e in which operation fluid flows and through which the operation fluid is supplied to the operation solenoid valve 6, the outlet passage 2f through which the operation fluid controlled by the operation solenoid valve 6 flows, and the through hole 2b through which the mounting screw 3 is inserted, the through hole 2b being communicated with the outlet passage 2f. The mounting screw 3 includes the inner passage 3h that allows communication between the operation port 131A and the outlet passage 2f. Accordingly, when the operation fluid is supplied to the operation solenoid valve 6 through the inlet passage 2e of the mounting block 2, the operation fluid having a flow rate controlled by the operation solenoid valve 6 is then output to the operation port 131A through the outlet passage 2f and the through hole 2b of the mounting block 2, and the inner passage 3h of the mounting screw 3.

Since the seal member 5 and the seal member 10 seal between the inner wall of the through hole 2b and the mounting screw 3, the operation fluid can be precisely supplied to the cylinder 131 at a flow rate controlled by the operation solenoid valve 6.

According to the mounting structure of a solenoid valve for operation in the present embodiment, consequently, the mounting block 2 attached with the operation solenoid valve 6 is mounted on the cylinder 131 by use of the internal threads of the operation port 131A which is threadedly engageable with a joint for connecting the tube 11. Thus, the operation solenoid valve 6 can be retrofitted to the existing cylinder 131. Further, the cylinder 131 can also be used both in a case of using the tube 11 and in a case of using the mounting block 2. Consequently, the cylinder 131 can be manufactured at low cost.

In the mounting structure of a solenoid valve for operation in the present embodiment, the recessed portion 3b is circumferentially formed on the outer peripheral surface of the shaft portion 3f of the mounting screw 3 and the inner passage 3h opens in the wall surface of the recessed portion 3b. Even when the mounting block 2 is mounted in any orientation on the cylinder 131, the outlet passage 2f is allowed to communicate with the inner passage 3h through the clearance S created between the recessed portion 3b and the inner circumferential surface of the through hole 2b, thereby allowing supply of the operation fluid to the operation port 131A. Consequently, according to the mounting structure of a solenoid valve for operation in the present embodiment, the mounting block 2 can be changeably mounted on the cylinder 131 in any desired orientation about the mounting screw 3.

In addition to the operations and effects of the aforementioned mounting structure, the fluid control valve 1 in the present embodiment can achieve a shorter passage between the operation solenoid valve 6 and the operation port 131A than in a structure using a tube to connect the operation solenoid valve 6 to the operation port 131A and thus can control the amount of operation fluid to be supplied at a position near the operation port 131A. Accordingly, even when the gas is to be supplied in small amounts at high frequency, the fluid control valve 1 in the present embodiment can perform opening and closing operations of the valve section 102 with good response. Therefore, the function sufficiently adaptable to an ALD process that forms a film by repeated switching of supply and exhaust of gas in short time can be added to the existing fluid control valve 1 with ease and low cost simply by replacing the tube 11 having been connected to the operation port 131A of the existing fluid control valve 1 by the mounting block 2 and then connecting the detached tube 11 to the mounting block 2.

In the present embodiment, the mounting screw 3 is circumferentially provided with the recessed portion 3b. Thus, when the operation solenoid valve to be retrofitted to the existing fluid control valve 1, the mounting block 2 and the operation solenoid valve 6 can be freely adjusted to face in any direction in relation to devices arranged around the fluid control valve 1. Thus, the operation solenoid valve 6 can be easily retrofitted.

Meanwhile, as shown in FIG. 11, for example, the mounting screw 3 threadedly engaging in the operation port 131A passes through the through hole 2b of the mounting block 2 without threaded connection with the mounting block 2. Further, the mounting block 2 is provided with the chamfered portions 2m and 2n in diagonally opposite positions, so that the mounting block 2 can be changed its mounting orientation without protruding in a radial direction from the upper end part 131C of the cylinder 131. In this way, for example, when the proximity sensor 12 is attached to the upper end part 131C as in the fluid control valve 1A shown in FIG. 11, the mounting block 2 can be rotated about the mounting screw 3 according to the position of the proximity sensor 12 to freely change the orientation of the operation solenoid valve 6.

The present invention is not limited to the aforementioned embodiments and may be embodied in other specific forms without departing from the essential characteristics thereof.

(1) In the above embodiment, for example, the mounting structure of a solenoid valve for operation is applied to the fluid control valve 1. As an alternative, the mounting structure of a solenoid valve for operation may be applied to another device provided with an operation port.

(2) In the above embodiment, for example, the mounting block 2 is made of aluminum and the steel ball 9 is made of stainless steel. However, their materials are not limited thereto. For instance, the mounting block 2 may be made of a resin having lower hardness than the steel ball 9. Further, the steel ball 9 may be welded to the mounting block 2. Still further, the opening of the bypass passage 2k may be sealed by rubber or molten metal filled therein.

(3) In the above embodiment, for example, the recessed portion 3b may be omitted.

(4) The number of fixing screws 7 for fixing the operation solenoid valve 6 to the mounting block 2 is not limited to two and may be set to one or set to three or more.

### REFERENCE SIGNS LIST

1, 1A Fluid control valve
2 Mounting block
2b Through hole
2e Inlet passage
2f Outlet passage
3 Mounting screw
3b Recessed portion
3h Inner passage
5 Seal member
6 Solenoid valve for operation

10 Seal member
131 Cylinder
131A Operation port
131AX Internal threads

1. A mounting structure of a solenoid valve for operation to mount the solenoid valve for operation on a cylinder provided with an operation port, the solenoid valve for operation being configured to control operation fluid to be supplied to the cylinder, wherein
the operation port has internal threads,
the mounting structure includes a mounting block to which the solenoid valve for operation is attached, and a mounting screw threadedly engaged with the internal threads to mount the mounting block to the cylinder,
the mounting block includes:
an inlet passage in which the operation fluid flows and through which the operation fluid is supplied to the solenoid valve for operation;
an outlet passage in which the operation fluid having been controlled by the solenoid valve for operation flows from the solenoid valve; and
a through hole through which the mounting screw is inserted, the through hole being communicated with the outlet passage,
the mounting screw includes an inner passage for providing communication between the operation port and the outlet passage, and
the mounting structure further includes a seal member for sealing between an inner wall of the through hole and the mounting screw.

2. The mounting structure of a solenoid valve for operation according to claim 1, wherein the mounting screw includes a shaft portion inserted through the through hole, the shaft portion having an outer peripheral surface formed circumferentially with a recessed portion having a wall surface in which the inner passage opens.

3. A fluid control valve provided with the mounting structure of a solenoid valve for operation according to claim 1.

4. A fluid control valve provided with the mounting structure of a solenoid valve for operation according to claim 2.
